(19) United States
(12) Patent Application Publication
(10) Pub. No.: US 2005/0010782 A1
(43) Pub. Date: Jan. 13, 2005

(54) Authentication system and ID generator

(75) Inventor: Kenichi Ohkubo, Katano-shi (JP)

Correspondence Address: FISH & RICHARDSON PC, 225 FRANKLIN ST, BOSTON, MA, 02110, US

(73) Assignee: Sanyo Electric Co., Ltd.

(21) Appl. No.: 10/873,096

(22) Filed: Jun. 21, 2004

(30) Foreign Application Priority Data
Jun. 20, 2003 (JP) 2003-176714

(51) Int. Cl. H04K 1/00

(52) U.S. Cl. 713/182

(57) ABSTRACT

A system for authenticating an external device attached to a main device. The system includes a first ID generator, arranged in the external device, for generating a first identification signal. A second ID generator, arranged in the main device, for generating a second identification signal. An authentication device compares the first and second identification signals and authenticates the external device based on the comparison result. The second ID generator is configured by a semiconductor device. Thus, the system has a high level of security with respect to the confidentiality of encryption information.

### CROSS-REFERENCE TO RELATED APPLICATIONS

This application is based upon and claims the benefit of priority from prior Japanese Patent Application No. 2003-176714, filed on Jun. 20, 2003, the entire contents of which are incorporated herein by reference.

### BACKGROUND OF THE INVENTION

The present invention relates to an authentication system and an ID generator, and more particularly, to an authentication system used when identifying whether or not an external device connected to a main device is the proper device.

A portable device, such as a portable phone, normally has a battery pack, which is detachably attached to the main body of the portable device. The battery pack includes a battery for supplying the main body with power. When, the battery deteriorates, the battery pack is replaced by a new one so that the portable device may be continuously used.

Progress made to reduce the manufacturing cost of the battery pack may decrease the quality of the battery pack. The portable device may not function properly when using such a battery pack. Further, such a battery pack may produce heat and cause an abnormality in the portable device.

Therefore, in the prior art, an identification signal is used to identify and authenticate an external device, such as a battery pack, that is connected to the main device. The identification signal enables recognition of an appropriate battery pack to confirm that there is no problem in the quality of the manufactured battery pack.

FIG. 1 is a schematic block diagram of a conventional authentication system 40 that identifies a battery pack 42 (external device), which is detachably attached to a portable device 41 (main device).

The portable device 41 includes a microcomputer 43. Data is communicated between the microcomputer 43 and an exclusive LSI 44, which is incorporated in the battery pack 42 so that the microcomputer 43 can identify the battery pack 42.

When the battery pack 42 is attached to the portable device 41, the microcomputer 43 activates an authentication processor 51 to generate a code (code sequence) for acquiring an identification signal (ID) from the portable device 41. The ID identifies whether or not the battery pack 42 is an appropriate one.

The code is provided to an encryption processor 55 of the LSI 44 via a communicator 53 of the microcomputer 43 and a communicator 54 of the LSI 44. The encryption processor 55 performs a predetermined operation (encryption processing) based on the received code to generate an identification signal for the battery pack 42 (first identification signal). The first identification signal is transferred to the authentication processor 51 via the communicators 54 and 53. The first identification signal is also provided to the encryption processor 52 of the microcomputer 43. The encryption processor 52 performs a predetermined operation (encryption processing) based on the code to generate an identification signal for the portable device 41 (second identification signal).

The authentication processor 51 compares the first identification signal and the second identification signal to determine whether the battery pack 42 is appropriate for the portable device 41.

The identification signal for the portable device 41 (second identification signal) is generated through software processing in the microcomputer 43. Thus, the encryption algorithm of the encryption processor 52, which generates the identification signal, must be disclosed to many software developers. As a result, there is a risk of encryption information leakage. Thus, the level of, confidentiality is insufficient.

### SUMMARY OF THE INVENTION

The present invention provides an authentication system having improved encryption information confidentiality.

To achieve the above object, the present invention provides a system for authenticating a first device attached to a second device. The system includes a first ID generator, arranged in the first device, for generating a first identification signal. A second ID generator, arranged in the second device, generates a second identification signal. An authentication device, arranged in the second device and connected to the first and second ID generators, receives the first and second identification signals from the first and second ID generators, compares the first and second identification signals, and authenticates the first device based on the comparison result.

A further aspect of the present invention is an ID generator for incorporation in a main device to which an external device is attached. The main device includes an authentication device for authenticating the external device based on a first identification signal of the external device and a second identification signal of the main device. The ID generator includes a communicator for performing a communication process with the authentication device. An encryption processor performs a predetermined encryption process on a code to generate the second identification signal and provide the second identification signal to the authentication device via the communicator. The communicator and the encryption processor are each configured by a semiconductor device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a prior art authentication system;

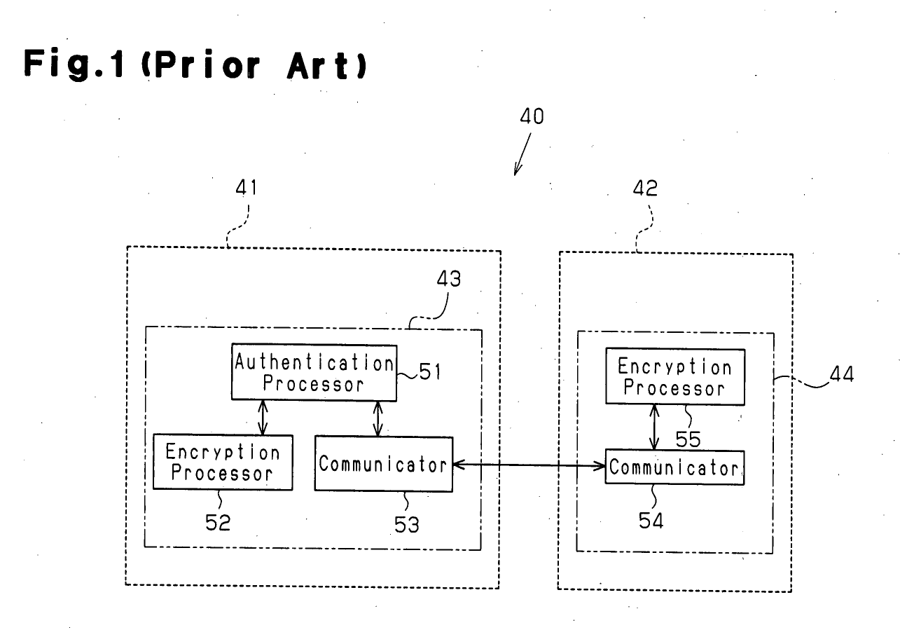

FIG. 2 is a schematic diagram showing an authentication system according to a preferred embodiment of the present invention; and

FIG. 3 is an explanatory diagram showing the configuration of the authentication system in detail.

### DETAILED DESCRIPTION OF THE PREFERRED EMBODIMENTS

In the drawings, like numerals are used for like elements throughout.

An authentication system 10 according to a preferred embodiment of the present invention will now be discussed with reference to the drawings. The authentication system 10 identifies a battery pack that is attached to a portable device, such as a portable phone.

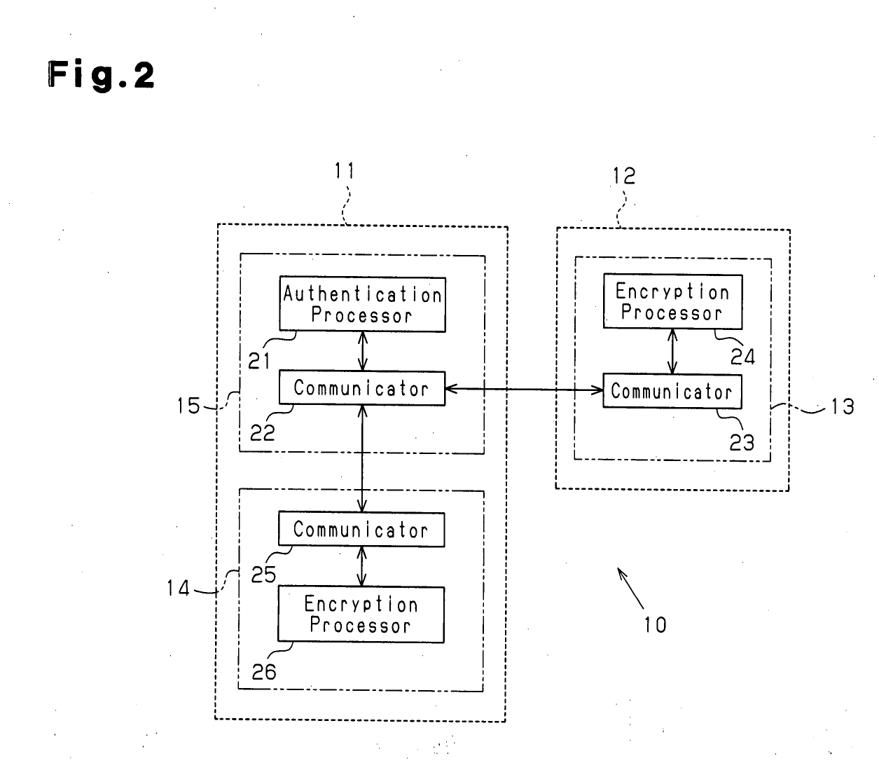

Referring to FIG. 2, a battery pack 12 (external device) is detachably attached to a portable device 11 (main device of a portable phone).

The battery pack 12 includes an exclusive LSI (first LSI) 13, which functions as a first ID generator. The portable device 11 includes an exclusive LSI (second LSI) 14, which functions as a second ID generator, and a microcomputer 15, which functions as an authentication device for identifying whether the battery pack 12 attached to the portable device 11 is an appropriate one. The microcomputer 15, the first LSI 13, and the second LSI 14 configure the authentication system 10. The battery pack 12 incorporates a battery (not shown), which is electrically connected to the portable device 11 by a power supply terminal (not shown).

The microcomputer 15 of the portable device 11 includes an authentication processor 21 and a communicator 22. The authentication processor 21 performs data communication with the first LSI 13 of the battery pack 12 and the second LSI 14 of the portable device 11 via the communicator 22 in accordance with a predetermined communication protocol.

The first LSI 13 is a semiconductor device including a communicator 23, which performs communication processing with the microcomputer 15, and an encryption processor 24, which generates an identification signal for the battery pack 12 (first identification signal) that is required to authenticate the battery pack 12. The encryption processor 24 receives data used to generate the identification signal from the authentication processor 21 and performs encryption processing on the received data in accordance with a predetermined encryption algorithm to generate the first identification signal.

The second LSI 14 is a semiconductor device including a communicator 25, which performs communication processing with the microcomputer 15, and an encryption processor 26, which generates an identification signal for the portable device 11 (second identification signal) that is required to authenticate the battery pack 12. The encryption processor 26 receives data used to generate the identification signal from the authentication processor 21 and performs encryption processing on the received data in accordance with the predetermined encryption algorithm to generate the second identification signal.

The encryption processor 24 of the first LSI 13 and the encryption processor 26 of the second LSI 14 perform encryption processing in accordance with the same encryption algorithm and generate the same identification signal for the same data provided from the authentication processor 21.

The authentication processor 21 compares the first identification signal, which is generated by the encryption processor 24 of the first LSI 13, and the second identification signal, which is generated by the encryption processor 26 of the second LSI 14, to determine whether the battery pack 12 is an appropriate one based on the comparison result. In the preferred embodiment, the battery pack 12 is determined as being the appropriate one when the first identification signal and the second identification signal are the same.

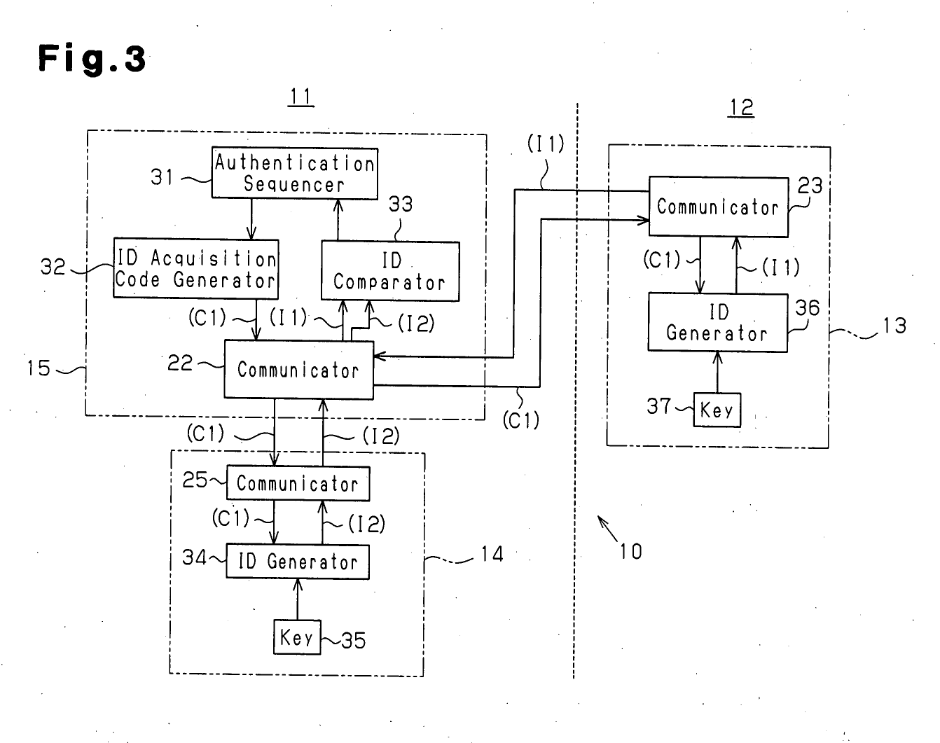

The detailed configuration and processing flow of the authentication system 10 will now be discussed with reference to FIG. 3.

The authentication processor 21 (FIG. 2) of the microcomputer 15 is divided in accordance with function into an authentication sequencer 31, an ID acquisition code generator (hereafter referred to as the “code generator”) 32, and an ID comparator 33. The encryption processor 26 (FIG. 2) of the second LSI 14 is divided in accordance with function into an ID generator 34 and a key data register 35 (denoted by “key” in FIG. 3). The encryption processor 24 (FIG. 2) of the first LSI 13 is divided in accordance with function into an ID generator 36 and a key data register 37 (denoted by “key” in FIG. 3).

The authentication sequencer 31 functions to control identification processing when authenticating the battery pack 12. That is, when the battery pack 12 is attached to the portable device 11, the authentication sequencer 31 first activates the code generator 32 in order to acquire an identification signal for the portable device 11 and an identification signal for the battery pack 12, which are required to authenticate the battery pack 12. The code generator 32 generates an ID acquisition code C1, which is required to generate the identification signals. In the preferred embodiment, the ID acquisition code C1 includes random data (code sequence) having a variable data length.

Then, the authentication sequencer 31 communicates with the first LSI 13 via the communicators 22 and 23 to transmit the ID acquisition code C1 generated by the code generator 32 to the ID generator 36 of the first LSI 13. The ID generator 36 uses key data, which is predetermined for the key data register 37, to perform a predetermined operation (encryption process) on the received ID acquisition code C1 and generate a first identification signal I1, which corresponds to code C1. The first identification signal I1 is transferred to the ID comparator 33 from the ID generator 36 via the communicators 23 and 22.

The authentication sequencer 31 communicates with the second LSI 14 via the communicators 22 and 25 to transmit the ID acquisition code C1 generated by the code generator 32 to the ID generator 34 of the second LSI 14. The ID generator 34 uses key data, which is predetermined for the key data register 35, to perform a predetermined operation (encryption process) on the received ID acquisition code C1 and generate a second identification signal 12, which corresponds to code C1. The second identification signal 12 is transferred to the ID comparator 33 from the ID generator 34 via the communicators 25 and 22.

The ID comparator 33 then compares the first identification signal I1 for the battery pack 12 provided from the first LSI 13 and the second identification signal 12 for the portable device 11 provided from the second LSI 14. Based on the comparison result, the authentication sequencer 31 determines whether the battery pack 12 is appropriate for the portable device 11. In other words, when the ID comparator 33 determines that the first identification signal I1 and the second identification signal 12 are the same, the authentication sequencer 31 determines that the appropriate battery pack 12 has been attached to the portable device 11.

The authentication system 10 of the preferred embodiment has the advantages described below.

(1) The portable device 11 is provided with the exclusive LSI (second LSI) 14, which includes the encryption processor 26 for generating the second identification signal 12 for the portable device 11 that is required to authenticate the battery pack 12. In this configuration, the algorithm for encryption processing is incorporated in the exclusive LSI 14. Thus, the confidentiality of the encryption algorithm is increased. This prevents leakage of the encryption information and realizes a system having high confidentiality.

(2) The encryption processor 26, which generates the second identification signal I2, is incorporated in the exclusive LSI (second LSI) 14 as hardware and not as software. Thus, the algorithm for encryption processing is undisclosed and exclusive. Accordingly, confidentiality is maintained at a high level with a relatively simple algorithm.

(3) An undisclosed and relatively simple encryption algorithm is used. This reduces the burden of developing software for the encryption process. Accordingly, the cost for producing a system having a high level of security is low.

(4) For authentication with the portable device 11, the encryption processor 26 of the exclusive LSI (second LSI) 14 performs data encryption processing, and the microcomputer 15 performs communication processing and authentication processing (code generation and identification signal comparison) with the first LSI 13 and the second LSI 14. Accordingly, the load on the microcomputer 15 is reduced.

(5) By exchanging the exclusive LSIs 13 and 14, the authentication system 10 is applicable for changes in the encryption algorithm for different types of devices.

(6) The ID generators 34 and 36, which perform a predetermined operation (encryption process) on the random code sequence (ID acquisition code C1) generated by the code generator 32, are respectively arranged in the portable device 11 and the battery pack 12. Accordingly, random data is communicated between the microcomputer 15 and the first LSI 13 and between the microcomputer 15 and the second LSI 14. This avoids making the authentication procedure for the battery pack 12 easily recognizable even if the communications are monitored.

(7) The ID generators 34 and 36, which perform the same operation to generate an identification signal, are respectively arranged in the portable device 11 and the battery pack 12. Thus, confidentiality is ensured and the identification process is properly performed.

It should be apparent to those skilled in the art that the present invention may be embodied in many other specific forms without departing from the spirit or scope of the invention. Particularly, it should be understood that the present invention may be embodied in the following forms.

The encryption processor 24 of the first LSI 13 in the battery pack 12 may be configured to perform encryption processing in accordance with a first algorithm, and the encryption processor 26 of the second LSI 14 in the portable device 11 may be configured to perform encryption processing in accordance with a second algorithm, which differs from the first algorithm. In this case, the ID comparator 33 is configured to compare the first identification signal and the second identification signal in accordance with the difference in the encryption processes.

The code generator 32 may transmit a first ID acquisition code to the first LSI 13 and a second ID acquisition code, which differs from the first ID acquisition code, to the second LSI 14. In this case, the ID comparator 33 is configured to compare the first identification signal and the second identification signal in accordance with the difference in the encryption processes.

The application of the present invention is not limited to a system for identifying a battery pack 12 attached to a portable device 11. For example, the present invention may be applied to any system that recognizes an external device detachably attached to a main device, such as a system that identifies an ink cartridge attached to a printer.

The present examples and embodiments are to be considered as illustrative and not restrictive, and the invention is not to be limited to the details given herein, but may be modified within the scope and equivalence of the appended claims.

1. A system for authenticating a first device attached to a second device, the system comprising;
a first ID generator, arranged in the first device, for generating a first identification signal;
a second ID generator, arranged in the second device, for generating a second identification signal; and
an authentication device, arranged in the second device and connected to the first and second ID generators, for receiving the first and second identification signals from the first and second ID generators, comparing the first and second identification signals, and authenticating the first device based on the comparison result.

2. The system according to claim 1, wherein the first device is an external device and the second device is a main device.

3. The system according to claim 2, wherein the external device is a battery pack and the main device is a portable device.

4. The system according to claim 1, wherein the first ID generator, the second ID generator, and the authentication device are each configured as a semiconductor device.

5. The system according to claim 1, wherein:
the authentication device generates a code that is required to generate the first and second identification signals;
the first ID generator includes:
a first communicator for performing a communication process with the authentication device on data including the code and the first identification signal; and
a first encryption processor for receiving the code via the first communicator and performing a predetermined encryption process on the received code to generate the first identification signal; and
the second ID generator includes:
a second communicator for performing a communication process with the authentication device on data including the code and the second identification signal; and
a second encryption processor for receiving the code via the second communicator and performing a predetermined encryption process on the received code to generate the second identification signal.

6. The system according to claim 5, wherein the authentication device includes:
a third communicator for performing a communication process with the first and second ID generators on data including the code, the first identification signal, and the second identification signal; and
an authentication processor for generating the code, receiving the first and second identification codes from the first and second ID generators, and comparing the first and second identification signals.

7. The system according to claim 1, wherein the authentication device includes:
a code generator for generating a code that is required to generate the first and second identification signals;
a first communicator for performing a communication process with the first and second ID generators on data including the code, the first identification signal, and the second identification signal; and
a comparator for receiving the first and second identification codes from the first and second ID generators via the first communicator and comparing the first and second identification signals.

8. The system according to claim 7, wherein:
the first ID generator includes:
a second communicator for performing a communication process with the first communicator of the authentication device; and
a first encryption processor for receiving the code from the code generator via the first and second communicators and performing a predetermined encryption process on the received code to generate the first identification signal; and
the second ID generator includes:
a third communicator for performing a communication process with the first communicator of the authentication device; and
a second encryption processor for receiving the code from the code generator via the first and third communicators and performing a predetermined encryption process on the received code to generate the second identification signal.

9. The system according to claim 8, wherein:
the code generator generates a common code for the first and second ID generators; and
the first and second encryption processors each perform the same encryption process on the common code to generate the associated identification code.

10. The system according to claim 8, wherein the code generator generates a first code, which is provided to the first ID generator, and a second code, which differs from the first code and which is provided to the second ID generator, and the comparator compares the first identification signal and the second identification signal in accordance with the difference in the codes.

11. The system according to claim 8, wherein the first encryption processor performs the encryption process on the received code in accordance with a first algorithm, the second encryption processor performs the encryption process on the received code in accordance with a second algorithm differing from the first algorithm, and the comparator compares the first identification signal and the second identification signal in accordance with the difference in the algorithms.

12. An ID generator for incorporation in a main device to which an external device is attached, the main device including an authentication device for authenticating the external device based on a first identification signal of the external device and a second identification signal of the main device, the ID generator comprising:
a communicator for performing a communication process with the authentication device; and
a encryption processor for performing a predetermined encryption process on a code to generate the second identification signal and providing the second identification signal to the authentication device via the communicator, the communicator and the encryption processor each being configured by a semiconductor device.

13. The ID generator according to claim 12, wherein the authentication device generates the code.

14. The ID generator according to claim 13, wherein the code is used to generate the first identification signal.

15. The ID generator according to claim 12, wherein the encryption processor uses predetermined key data in the encryption process to generate the second identification signal.
